(19) United States
(12) Patent Application Publication
(10) Pub. No.: US 2014/0198706 A1
(43) Pub. Date: Jul. 17, 2014

(54) MULTICAST SOURCE REGISTRATION METHOD, MULTICAST RECEIVER JOINING METHOD AND MULTICAST SERVICE PROVIDING METHOD DURING HANDOVER

(71) Applicants: Il-Gu Jung, Daejeon (KR); Seng-Kyoun Jo, Cheongju-si Chungcheongbuk-do (KR); Kyoung-Hee Lee, Daejeon (KR); Hyun-Woo Lee, Daejeon (KR); Won Ryu, Daejeon (KR)

(72) Inventors: Il-Gu Jung, Daejeon (KR); Seng-Kyoun Jo, Cheongju-si Chungcheongbuk-do (KR); Kyoung-Hee Lee, Daejeon (KR); Hyun-Woo Lee, Daejeon (KR); Won Ryu, Daejeon (KR)

(73) Assignee: Electronics and Telecommunications Research Institute, Daejeon (KR)

(21) Appl. No.: 14/125,272

(22) PCT Filed: Sep. 25, 2012
(86) PCT No.: PCT/KR2012/007695

§ 371 Date: Dec. 10, 2013

(30) Foreign Application Priority Data
Sep. 29, 2011 (KR) 10-2011-0099262
Jul. 2, 2012 (KR) 10-2012-0071946

(51) Int. Cl. H04W 4/08; H04L 12/18; H04W 36/00

(52) U.S. Cl. CPC H04W 4/08; H04W 36/0005; H04L 12/185
USPC 370/312

(57) ABSTRACT

Disclosed are a multicast source registration method, a multicast receiver joining method and a multicast service providing method during handover, in which another mobile node may constantly receive multicast data even when a mobile node performs handover while transmitting multicast data in various mobile networks. According to the present invention, a safe and fast mobility of a network-based multicast source can be provided.

### TECHNICAL FIELD

The present invention relates to mobility support for multicast traffic, and more particularly, to a multicast source registration method, a multicast receiver joining method and a method of providing a multicast service during a handover, whereby a mobile node is enabled to seamlessly receive multicast data transmitted from another mobile node that performs a handover across heterogeneous mobile networks.

### BACKGROUND ART

Data transmission is performed using a unicast scheme to transmit the data to one receiver, using a broadcasting scheme to transmit the data to all receivers within the same network, or using a multicast scheme to transmit the data only to subscriber nodes that are joining/subscribing to a particular group. In an Internet protocol (IP) multicast scheme, with respect to a single packet transmitted from a multicast source, as many independent copies of the packet as the number of receivers are generated and each is delivered to the individual receivers within a network. Hence, as compared with a case in which individual packets are delivered to the respective receivers without copying the same packet, an overhead may be reduced and a bandwidth may be saved since there is no need of transmitting a number of packets over the network.

Recently, a variety of application services using multicasting technologies have been introduced, and with the rapid development of high-performance mobile terminals, such as smartphones, these application services are provided by taking into consideration a situation where a receiver terminal or transmission terminal of multicast data is fixed at a location or even moving.

To support the movement of a mobile node from one network to another network, the existing multicast technology, which is dedicated to a fixed terminal, requires an additional method to efficiently process a handover.

In a wireless mobile environment, a wireless domain largely affects the stability and performance of a multicast service. The wireless domain is very limited in resources, and has a slower data transfer rate than the wired domain.

The restricted environment of the wireless domain may cause loss of a signaling message transmitted between a mobile node and a router for using a multicast service. Such loss may be increased when the mobile node hands over from one network to another while transmitting or playing back a multicast stream, and thus a user of the mobile node may regard this increase in loss as more problematic than it may actually be because it occurs while the user is using the multicast stream.

However, even when there is no loss of the signaling message during a handover, a handover delay time may be prolonged due to the slow data transfer rate in a wireless domain, and it may result in an interrupted display of a video currently being viewed.

### Technical Problem

The following description relates to a multicast source registration method, a multicast receiver joining method and a method of providing a multicast service during a handover, whereby a multicast router function and mobility are managed and receiver terminals are enabled to seamlessly receive multicast data from a mobile node acting as a multicast source while the mobile node continuing to transmit the multicast data hands over between different mobile networks.

According to the present invention, while a mobile node acting as a multicast source hands over from one wireless network to another wireless network, a receiver terminal is enabled to seamlessly receive multicast traffic from the mobile node by controlling a multicast traffic path only with utilizing functions of a network mobility management system and of a multicast router and without the involvement of the multicast source mobile node.

### Technical Solution

In one general aspect, a multicast source registration method includes detecting, at a mobile router (MR), a multicast packet transmitted from a mobile node (MN), registering the multicast packet, and delivering the multicast packet to a multicast router (rendezvous point (RP)) that performs multicast relay; transmitting, at the MR, a message to a handover control agent (HCA) that indicates that the MN acts as a multicast source; and transmitting, at the HCA, a message to a mobility information control server (MICS) to request to register the MN and receiving a response to the message.

In another general aspect, a multicast receiver joining method includes detecting, at a multicast router (rendezvous point (RP)), joining of a new receiver that wishes to receive multicast traffic being transmitted; and sending, at the RP, a message to a mobility information control server (MICS) that indicates that there is the new receiver joining a particular multicast group.

In yet another general aspect, a method of providing a multicast service during a handover includes in response to handover of a mobile node (MN) that is transmitting multicast traffic, delivering, at a new handover control agent (HCA) of a new network to which the MN is connected, a message to a mobility information control server (MICS) to request to register a location of the MN; in response to the message being received, delivering, at the MICS, a message to a multicast router (rendezvous point (RP)), which performs multicast relay, to request to create a tunnel to a new mobile router (MR) connected to the new HCA; creating, at the RP, a tunnel to the new MR and preparing for receiving the multicast traffic; in response to a location registration completion message being received from the MICS, issuing, at the new HCA, an instruction to the new MR, to which the MN is transmitting the multicast traffic, to create a tunnel to the particular RP and deliver the multicast traffic to the RP; and delivering the multicast traffic transmitted from the MN to the RP over the created tunnel and delivering, at the RP, the received multicast traffic to a receiver.

### Advantageous Effects

As described above, according to the exemplary embodiments of the present invention, a multicast router function and mobility management method are provided which enables seamless multicast data transmission to receiver terminals, during handover of a mobile node, which acts as a multicast source transmitting the multicast data in various mobile wireless networks.

In addition, it is possible to enable receiver terminals to fast and seamlessly receive multicast data, while a mobile node acting as a multicast source hands over between different wireless networks, by controlling a multicast traffic path only with utilizing functions of a network mobility management system and a multicast router and without the involvement of the multicast source mobile node.

### DESCRIPTION OF DRAWINGS

FIG. 1 is a diagram illustrating a configuration of a network that supports network-based mobile multicast source mobility according to an exemplary embodiment of the present invention.

FIG. 2 is a block diagram illustrating a mobile router (MR)/multicast router (RP) capable of multicasting and responsible for multicast relay, a handover control agent (HCA) and a mobility information control server (MICS) which are shown in FIG. 1.

FIG. 3 is a diagram illustrating an example of a change in a transfer path of multicast data during MN's handover, wherein the MN, as a multicast traffic source, is transmitting the multicast data to a different terminal that is a multicast traffic receiver.

FIG. 4 is a flowchart of an example of a signaling message delivery process when an MN transmits initial multicast data.

FIG. 5 is a flowchart illustrating an example of a signaling message delivery process when a different terminal, as a multicast receiver, starts receiving (joining) multicast data after the completion of the procedures illustrated in FIG. 4.

FIGS. 6A to 6C are flowcharts illustrating examples of a signaling message delivery process during MN's handover.

FIG. 7 is a flowchart illustrating an example of a signaling message delivery process when an MN does not transmit multicast traffic any longer after handover.

### MODE FOR INVENTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In the following description, a method of enabling receiver mobile nodes to seamlessly receive multicast traffic, while a mobile node acting as a multicast source transmitting the multicast traffic hands over between different wireless networks, by controlling a multicast traffic path only with utilizing functions of a network mobility management system and a multicast router and without the involvement of the multicast source mobile node is provided. This method may provide safer, faster network-based multicast source mobility, as compared to a case where the mobile node is involved.

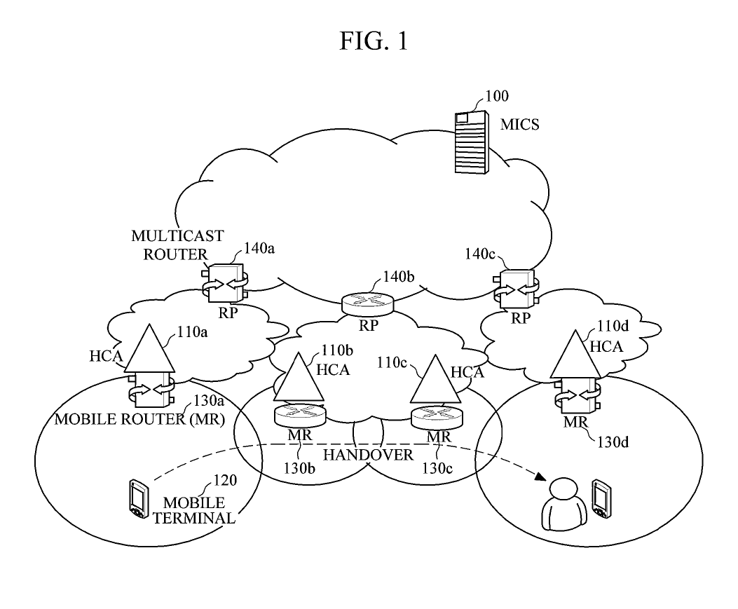

FIG. 1 is a diagram illustrating a configuration of a network that supports network-based mobile multicast source mobility according to an exemplary embodiment of the present invention.

A mobility information control server (MICS) 100 and handover control agents (HCAs) 110a, 110b, 110c, and 110d are general control plane devices that control mobility of mobile nodes (MNs) 120 in an IP-based core network, and each has additional functions to support mobile multicast source mobility, as well as general functions, in accordance with the embodiment of the present invention.

Mobile routers (denoted as MR (multicast router) in FIG. 1) 130a, 130b, 130c, and 130d capable of multicasting and multicast routers (denoted as RP (rendezvous point)) 140a, 140b, and 140c responsible for multicast relay have additional functions for supporting mobile multicast source mobility, as well as general multicast router functions, in accordance with the embodiment of the present invention.

The MICS 100 manages location information of the MN 120 and information regarding current communication state of the MN 120. In addition, the MICS 100 has an information service management function in accordance with IEEE 802.21 Media Independent Handover (MIH) technology so as to enable the MN 120 that is located at a position where a number of access networks are overlapping to select an appropriate access network, and also has a function for managing multicast source-related information of an individual MN and a communication function for communicating with a multicast router functioning as an RP in an effort to support the mobility.

Handover is performed when the MN connected to the MR 130a is transferred from the current network to a different network. Upon recognizing that the new MN 120 is connected to the access network, the HCA 110d in the corresponding network registers and manages layer-2 identification (L2ID) information (MAC address) of the MN 120, adds location information (Care of Address (CoA)) of the MN 120 to the L2ID information and requests the MICS 100 to register a location of the MN 120.

The HCA 110d further includes a function for managing multicast source-related information of an individual MN and a communication function for communicating with a mobile router (i.e., multicast router (MR)) capable of multicasting so as to support the mobility according to the exemplary embodiment of the present invention.

The MRs 130a, 130b, 130c, and 130d capable of multicasting and the HCAs 110a, 110b, 110c, and 110d may be physically separated as shown in FIG. 1, or alternatively be physically integrated into one device. The MRs 130a, 130b, 130c, and 130d each have a basic multicast function and additional functions for supporting network-based mobile multicast source mobility.

The multicast routers (RPs) 140a, 140b, and 140c responsible for multicast relay have a general multicast function and additional functions for supporting the network-based mobile multicast source mobility.

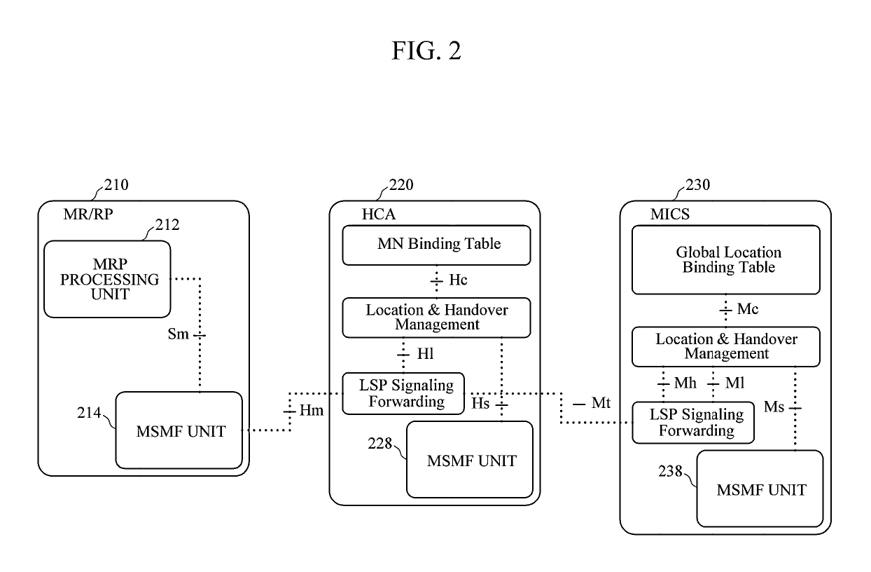

FIG. 2 is a block diagram illustrating a mobile router (MR)/multicast router (RP) capable of multicasting and responsible for multicast relay, a handover control agent (HCA) and a mobility information control server (MICS) which are shown in FIG. 1.

The multicast router (MR/RP) 210 includes a multicast routing protocol (MRP) processing unit 212 and a multicast source management function (MSMF) unit 214 so as to support network-based mobile multicast source mobility.

The MRP processing unit 212 may process existing multicast protocols, such as the protocol independent multicast (PIM) protocol. In addition to the function for processing existing multicast protocols, the MR/RP 210 may also have a function for monitoring a multicast source's process to register initial multicast traffic to the MR/RP 210 and collecting and reporting the monitoring result to the MSMF unit 214, a function for monitoring the multicast source's process to terminate transmitting the current multicast traffic and collecting and reporting the monitoring result to the MSMF unit 214, a function for establishing a tunnel with an IP address of the MR/RP 210 provided by the MSMF 214 and transferring multicast traffic over the tunnel, and a function for deleting the tunnel in response to an instruction from the MSMF unit 214.

The MRP processing unit 212 of the MR/RP 210 is capable of processing existing protocols, such as PIM protocol. In addition to the function for processing the existing protocols, such as PIM protocol, the MR/RP also includes a function for reporting to the MSMF unit 214 that there is a new receiver that receives multicast traffic transferred from the multicast source, a function for establishing a tunnel with an IP address of the MR/RP 210 provided by the MSMF unit 214, a function for receiving multicast traffic sent by the MR/RP 210 over the tunnel, and a function for deleting the tunnel in response to an instruction from the MSMF unit 214.

The MSMF unit 214 of the MR/RP 210 acts to deliver a control message between the MRP processing unit 212 and an HCA 220, and also to deliver a control message between the MRP processing unit 212 and the MICS 230. The HCA 220 and the MICS 230 include, respectively, MSMF units 228 and 238, which are named the same as the MSMF unit 214 included in the MR/RP 210. The MSMF units 228 and 238 of the HCA 220 and the MICS 230 differ from the MSMF unit 214 of the MR/RP 210 in their specific functions.

The MSMF unit 228 of the HCA 220 manages multicast source role information of each MN in association with an MN binding table, and the MSF unit 238 of the MICS 230 manages multicast source information of each MN in association with a global location binding table. In addition, the MSMF units 228 and 238 of the HAC 220 and the MICS 230 post-process messages required for processing handover of multicast traffic of an MN during a handover event. The other functions of the HCA 220 and the MICS 230 are described in a prior art, Korean Laid-Open Patent Publication No. 10-2009-0060926.

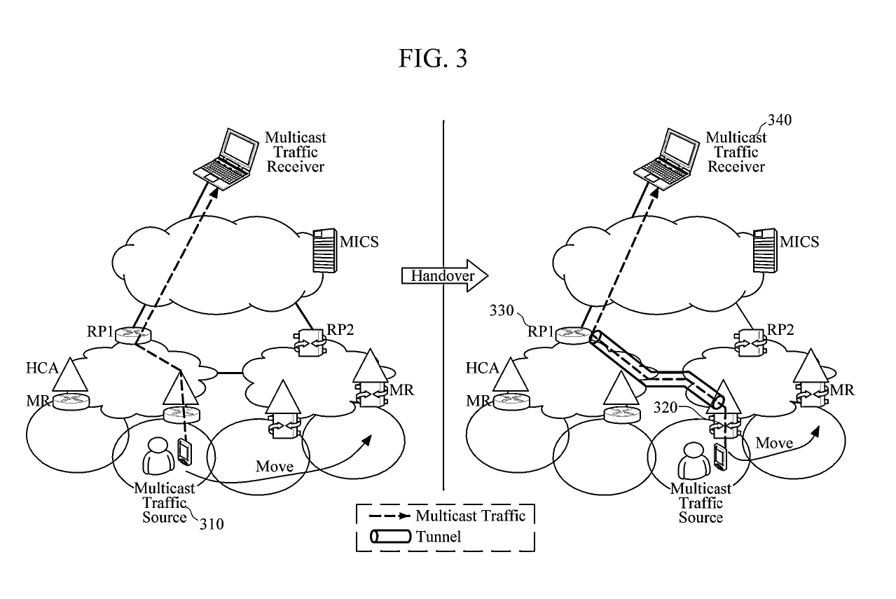

FIG. 3 is a diagram illustrating an example of a change in a transfer path of multicast data during MN's handover, wherein the MN, as a multicast traffic source, is transmitting the multicast data to a different terminal that is a multicast traffic receiver.

As shown in FIG. 3, during handover of the MN 310 which acts as a multicast traffic source to transmit multicast data, a tunnel is established between an MR 320 of an area to which the MN moves and an RP1 330 of an old area in which the MN is previously present, and the MN 310 seamlessly transmits multicast traffic over the tunnel. Accordingly, the multicast traffic receiver 340 can receive seamless multicast traffic.

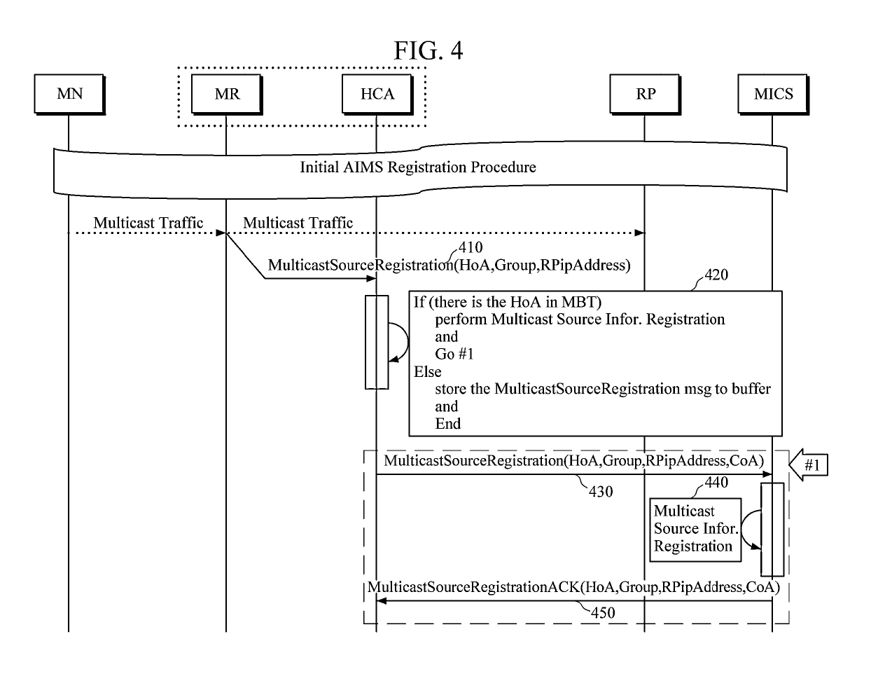

FIG. 4 is a flowchart of an example of a signaling message delivery process when an MN transmits initial multicast data.

In response to the initial multicast traffic being transmitted from the MN, an MRP processing unit of an MR detects and registers the initial multicast traffic, and then delivers the multicast traffic to an RP that performs multicast relay, and notifies to an MSMF unit of the MR that the above procedures have proceeded. In response to the notification being received from the MRP processing unit, the MSMF unit of the MR transmits a message (MulticastSourceRegistration) to an HCA to notify that the particular MN starts acting as the multicast source in 410.

The message (MulticastSourceRegistration message) includes information about an IP address (Home of Address (HoA)) of the MN, a multicast group address (denoted as Group in FIG. 4) and an IP address (denoted as RPipAddress in FIG. 4) of an RP that has registered corresponding multicast traffic.

In response to the reception of the message, an MSMF unit of the HCA searches an MN binding table based on the delivered IP address (HoA) of the MN, and performs signaling based on the search result in 420. For example, if the IP address (HoA) of the MN is found in the MN binding table, the MSMF unit of the HCA stores the information included in the message in the MN binding table and delivers the same information to an MICS via a signaling message (MulticastSourceRegistration message) in 430. At this time, the HCA delivers its own IP address (Care of Address (CoA)) along with the signaling message to inform to the MICS that the HCA is currently managing the corresponding MN.

On the contrary, if the IP address (HoA) of the MN is not found in the MN binding table, it may indicate that the MN may have already been handed over, and hence the MICS stores the message (MulticastSourceRegistration message) in a buffer for a predetermined period of time, and thereby the message can be taken as a reference during the handover processing procedures. Then, the flow is terminated.

In the meantime, in response to the message (MulticastSourceRegistration message) being received from the HCA to inform that the particular MN starts acting as a multicast source, an MSMF unit of the MICS stores the relevant information in a global location binding table in 440, and sends a message (MulticastSourceRegistrationACK message) to the HCA to inform that the MSMF unit has successfully received the information in 450.

Through these procedures, the HCA and the MICS can learn which MN is acting as a source.

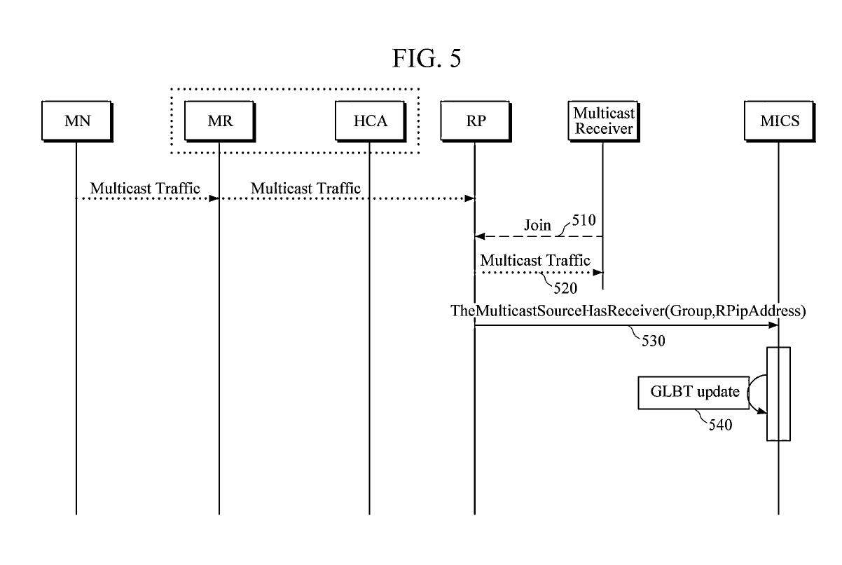

FIG. 5 is a flowchart illustrating an example of a signaling message delivery process when a different terminal, as a multicast receiver, starts receiving (joining) multicast data after the completion of the procedures illustrated in FIG. 4.

If a multicast receiver joins multicast traffic stream while the multicast traffic is being transmitted in 510, an MRP processing unit of the RP delivers the multicast traffic to the multicast receiver in 520 and notifies the delivery of the multicast traffic to the MSMF unit of the RP. The MSMF unit of the RP delivers a message (TheMulticastSourceHasReciever message) to the MICS to notify that there is the multicast receiver joining a particular multicast group in 530. In response to the message being received, the MSMF unit of the MICS searches for the corresponding multicast group in the global location binding table and displays the presence of the receiver joining the multicast group in 540.

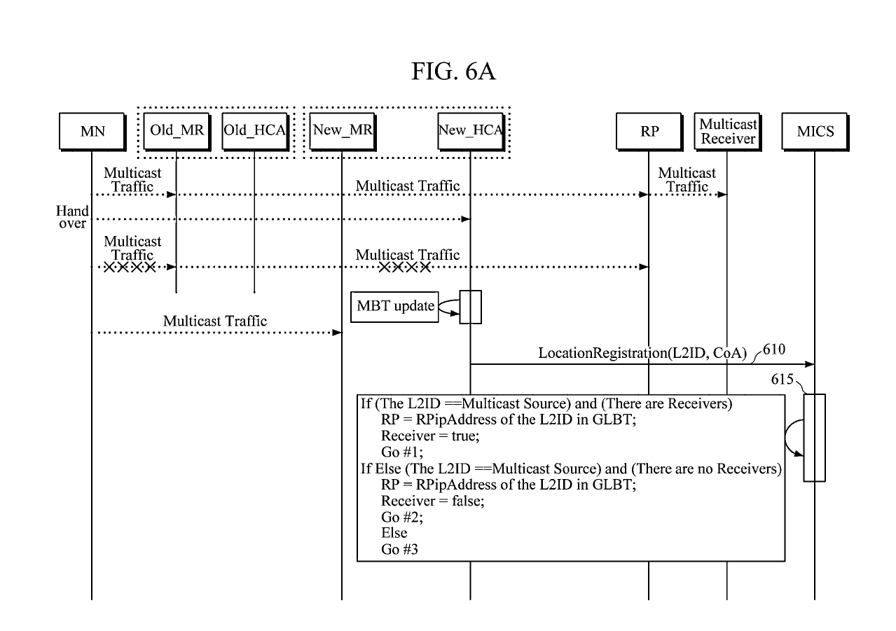

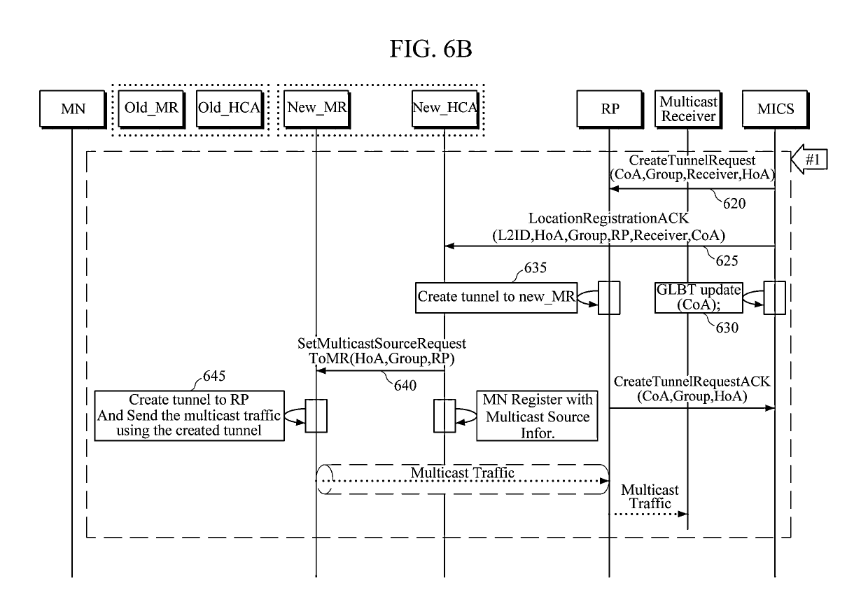

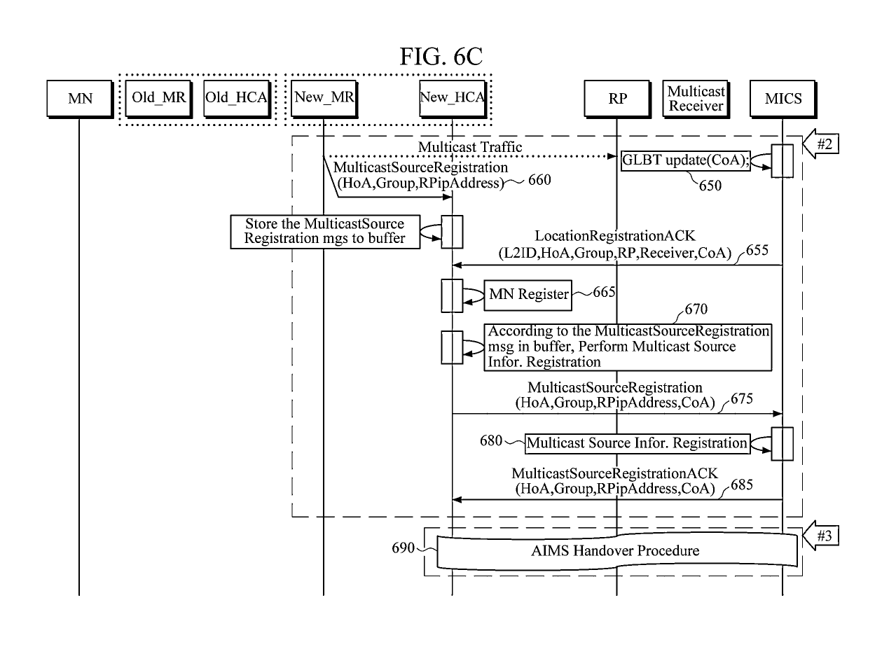

FIGS. 6A to 6C are flowcharts illustrating examples of a signaling message delivery process during MN's handover.

During handover of an MN to a different network while the MN as a multicast traffic source is transmitting multicast traffic, a new HCA receives a handover event of the MN and delivers a message (LocationRegistration message) to the MICS to register a location of the MN in the MICS in 610. In response to the message being received, the MICS searches the global location binding table so as to register the location of the MN in 615.

If it is found that the corresponding MN is performing handover and acting as a multicast source and there is a receiver terminal receiving the multicast traffic, in 620, the MICS delivers a tunnel creation request message (CreateTunnelRequest message) to the RP to request to establish a new tunnel to a new MR to which the new HCA is connected.

At the same time, in 625, the MICS delivers a location registration completion message (LocationRegistrationACK message) to the new HCA to inform that the MN whose location registration is requested by the new HCA is already acting as a multicast source and there is a receiver terminal receiving the multicast traffic. Then, the MICS updates the new location (CoA) of the MN in the global location binding table in 630.

In the meantime, in response to the tunnel creation request message being received from the MICS, the RP creates a tunnel to the new MR and prepares for receiving the multicast traffic in 635. In 640, in response to the location registration completion message (LocationRegistrationACK message) being received from the MICS, the new HCA recognizes that the MN whose location is requested for registration through the message is acting as the multicast source, and delivers a message (SetMulticastSourceRequestToMR) to the new MR through its MCMF unit so as to request that the new MR to which the MN is transmitting the multicast traffic establishes a tunnel to the particular RP and delivers the multicast traffic to the RP over the tunnel.

In response to the reception of the message (SetMulticastSourceRequestToMR message), an MSMF unit of the new MR establishes a tunnel to the RP and delivers the multicast traffic from the MN to the RP over the established tunnel in 645. In response to the reception of the multicast traffic, the RP delivers seamlessly the multicast traffic to the receiver that has been receiving the multicast traffic.

On the contrary, in response to the reception of the location registration completion message (LocationRegistrationACK message) from the new HCA, the MICS searches the global location binding table to register the location of the MN, and if the determination is made from the search result that the MN is acting as the multicast source and there is no other receiver terminals receiving the multicast traffic from the MN, the MICS updates the new location (CoA) of the MN in the global location binding table in 650. In addition, in 655, the MICS delivers a location registration completion message (LocationRegistrationACK message) indicating that the MN whose location registration has been requested by the new HCA is already acting as a multicast source and there is no receiver terminals receiving the multicast traffic.

Meanwhile, in this case where the MN is acting as a multicast source and there is no other receiver terminals receiving the multicast traffic, in 660, the new HCA is temporarily storing the message (MulticastSourceRegistration message) in a buffer during processing the message which was received from the new MR that indicates that the new MR has received the multicast traffic from the MN and registered the multicast traffic in the RP associated with the MR.

In response to the location registration completion message being received from the MICS, the new HCA registers the location of the MN in the MN binding table in 665, and compares the content of the message in the buffer with the content of the location registration completion message to register multicast source information of the MN in 670. Thereafter, the new HCA delivers the multicast source information of the MN to the MICS through the signaling message (MulticastSourceRegistration message) in 675. The MSMF unit of the MICS stores the received message in the global location binding table in 680, and sends a message (MulticastSourceRegistrationACK message) to the HCA that indicates that the message has been successfully processed in 685.

In response to the location registration request message from the new HCA, the MICS searches the global location binding table for registration of the MN's location, and if a determination is made, based on the search result, that the MN is not acting as a multicast source, general handover procedures are executed in 690.

Through the above process, the multicast source terminal (MN) can seamlessly provide multicast traffic to the receiver during handover between networks.

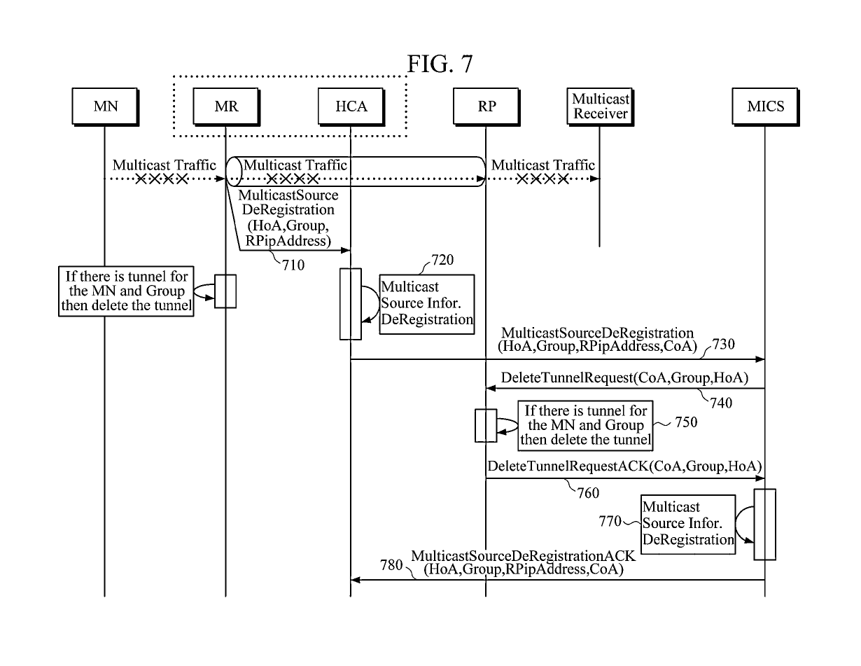

FIG. 7 is a flowchart illustrating an example of a signaling message delivery process when an MN does not transmit multicast traffic any longer after handover.

Upon MN's terminating the transmission of multicast traffic, an MRP processing unit of an MR detects it, and reports the termination to an MSMF unit of the MR. In response to the report, the MSMF unit of the MR sends a signaling message (MulticastSourceDeRegistration message) to an HCA to inform of the termination, and deletes a tunnel for use as a transmission path in 710.

In response to the message (MulticastSourceDeRegistration message) being received from the MR, an MSMF unit of the HCA deletes multicast source information of the corresponding MN from an MN binding table, and delivers the signaling message (MutlicastSourceDeRegistration message) to the MICS to send the same information in 730.

At this time, the HCA delivers its IP address (CoA) along with the signaling message so as to inform to the MICS that it is the HCA that is currently managing the corresponding MN. In response to the reception of the message (MulticastSourceDeRegistration message) that indicates the particular MN terminates transmission of multicast traffic, the MSMF unit of the MICS sends a message (DeleteTunnelRequest) to an RP, which performs multicast traffic relay, to request to delete a tunnel for use as a transmission path in 740.

The RP determines whether the corresponding tunnel is present or not, and, if it is present, deletes the tunnel in 750, and sends a message (DeleteTunnelRequestACK message) to the MICS that indicates that the tunnel has been successfully deleted in 760. In response to the message (DeleteTunnelRequestACK message), the MSMF unit of the MICS deletes multicast source information of the corresponding MN from a global location binding table in 770, and sends a message (MulticastSourceDeRegistrationACK message) to the HCA that indicates that the corresponding information has been successfully processed in 780.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### INDUSTRIAL APPLICABILITY

The present invention can be efficiently applied to a multicast traffic mobility management field.

1. A multicast source registration method comprising:
detecting, at a mobile router (MR), a multicast packet transmitted from a mobile node (MN), registering the multicast packet, and delivering the multicast packet to a multicast router (rendezvous point (RP)) that performs multicast relay;
transmitting, at the MR, a message to a handover control agent (HCA) that indicates that the MN acts as a multicast source; and
transmitting, at the HCA, a message to a mobility information control server (MICS) to request to register the MN and receiving a response to the message.

2. The multicast source registration method of claim 1, wherein the message to indicate that the MN acts as a multicast source includes an Internet protocol (IP) address (Home of Address (HoA)) of the MN, a multicast group address, and an IP address of the RP at which the multicast traffic has been registered.

3. The multicast source registration method of claim 2, further comprising:
searching, at the HCA, for the received IP address (HoA) of the MN in an MN binding table.

4. The multicast source registration method of claim 3, further comprising:
in response to the searching result indicating that the received IP address is present in the MN binding table, transmitting corresponding information to the MICS through a signaling message, and in response to the searching result indicating that the received IP address is not present in the MN binding table, temporarily storing the received IP address in a buffer.

5. A multicast receiver joining method comprising:
detecting, at a multicast router (rendezvous point (RP)), joining of a new receiver that wishes to receive multicast traffic being transmitted; and
sending, at the RP, a message to a mobility information control server (MICS) that indicates that there is the new receiver joining a particular multicast group.

6. The multicast receiver joining method of claim 5, further comprising:
in response to receiving the message, searching, at the MICS, for the multicast group in a global location binding table and displaying information indicating that there is the new receiver joining the multicast group.

7. The multicast receiver joining method of claim 5, wherein the message that indicates that there is the new receiver joining the particular multicast group is TheMulticastSourceHasReceiver message.

8. A method of providing a multicast service during a handover, comprising:
in response to handover of a mobile node (MN) that is transmitting multicast traffic, delivering, at a new handover control agent (HCA) of a new network to which the MN is connected, a message to a mobility information control server (MICS) to request to register a location of the MN;
in response to the message being received, delivering, at the MICS, a message to a multicast router (rendezvous point (RP)), which performs multicast relay, to request to create a tunnel to a new mobile router (MR) connected to the new HCA;
creating, at the RP, a tunnel to the new MR and preparing for receiving the multicast traffic;
in response to a location registration completion message being received from the MICS, issuing, at the new HCA, an instruction to the new MR, to which the MN is transmitting the multicast traffic, to create a tunnel to the particular RP and deliver the multicast traffic to the RP; and
delivering the multicast traffic transmitted from the MN to the RP over the created tunnel and delivering, at the RP, the received multicast traffic to a receiver.

9. The method of claim 8, further comprising:
in response to the location registration message being received, searching for, at the MICS, relevant information in a global location binding table.
